(19) United States
(12) Patent Application Publication
(10) Pub. No.: US 2013/0175891 A1
(43) Pub. Date: Jul. 11, 2013

(54) SWITCHED RELUCTANCE MOTOR

(71) Applicant: SAMSUNG ELECTRO-MECHANICS CO., LTD., Gyunggi-do (KR)

(72) Inventors: Byeong Han Kim, Gyunggi-do (KR); Guen Hong Lee, Gyunggi-do (KR); Chang Hwan Choi, Gyunggi-do (KR); Han Kyung Bae, Gyunggi-do (KR)

(73) Assignee: SAMSUNG ELECTRO-MECHANICS CO., LTD., Gyunggi-do (KR)

(21) Appl. No.: 13/713,845

(22) Filed: Dec. 13, 2012

(30) Foreign Application Priority Data
Dec. 16, 2011 (KR) 10-2011-0136611

(51) Int. Cl. F04D 13/06; H02K 1/24

(52) U.S. Cl. CPC F04D 13/06; H02K 1/246
USPC 310/48; 417/356

(57) ABSTRACT

Disclosed herein is a switched reluctance motor including: a rotor part including a rotor core of which a shaft is fixedly coupled to a central portion and a plurality of rotor poles protruding from the rotor core; a stator part including a stator yoke rotatably receiving the rotor part therein and a plurality of stator salient poles protruding from the stator yoke so as to face the rotor poles; and auxiliary rotor poles coupled to outer portions of the rotor poles to rotate integrally with the rotor part.

### CROSS REFERENCE TO RELATED APPLICATION

This application claims the benefit of Korean Patent Application No. 10-2011-0136611, filed on Dec. 16, 2011, entitled “Switched Reluctance Motor”, which is hereby incorporated by reference in its entirety into this application.

### BACKGROUND OF THE INVENTION

1. Technical Field

The present invention relates to a switched reluctance motor.

2. Description of the Related Art

Generally, in order to transfer an external fluid to the desired place, a scheme of using a device such as a pump or a fan is used. In this scheme, liquid or gas is transferred to the desired place using a propeller provided at one end of a shaft configuring the motor.

However, in the case in which the propeller is disposed at one end of the shaft rotating integrally with the motor, a size of the motor may be increased, and manufacturing cost may be increased since the propeller should be additionally manufactured.

### SUMMARY OF THE INVENTION

The present invention has been made in an effort to provide a switched reluctance motor including a rotor part having a propeller shape.

According to a first preferred embodiment of the present invention, there is provided a switched reluctance motor including: a rotor part including a rotor core to which a shaft is fixedly coupled to a central portion thereof and a plurality of rotor poles protruding from the rotor core; a stator part including a stator yoke rotatably receiving the rotor part therein and a plurality of stator salient poles protruding from the stator yoke so as to face the rotor poles; and auxiliary rotor poles coupled to outer portions of the rotor poles to rotate integrally with the rotor part.

The auxiliary rotor pole may be made of any one of a plastic material and a synthetic resin.

The switched reluctance motor may further include coils wound around the stator salient pole multiple times.

The auxiliary rotor pole may be fixedly coupled to the outer portion of the rotor pole so as to be disposed at a fluid suction channel formed between the rotor poles.

A cross-section of the rotor part in which the auxiliary rotor pole is fixedly coupled to the outer portion of the rotor pole may be a propeller shape.

The stator salient pole may have a skew shape having a predetermined angle.

According to a second preferred embodiment of the present invention, there is provided a switched reluctance motor including: a rotor part including a rotor core to which a shaft is fixedly coupled to a central portion thereof and a plurality of rotor poles protruding from the rotor core; a stator part including a stator yoke rotatably receiving the rotor part therein and a plurality of stator salient poles protruding from the stator yoke so as to face the rotor poles, wherein the rotor pole is inclined by a predetermined angle based on the shaft.

The rotor pole may have a skew shape in which the rotor pole is inclined from one end to a distal end by a predetermined angle based on the shaft.

A cross-section of the rotor part may be a propeller shape.

The switched reluctance motor may further include coils wound around the stator salient pole multiple times.

The stator salient pole may have a skew shape having a predetermined angle.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of a switched reluctance motor according to a first preferred embodiment of the present invention;

FIG. 2 is an assembly perspective view of a rotor part and auxiliary rotor poles shown in FIG. 1;

FIG. 3 is a cross-sectional view showing the rotor part and the auxiliary rotor pole shown in FIG. 2;

FIG. 4 is an exploded perspective view of a switched reluctance motor according to a second preferred embodiment of the present invention; and

FIG. 5 is a perspective view of a rotor part shown in FIG. 4.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

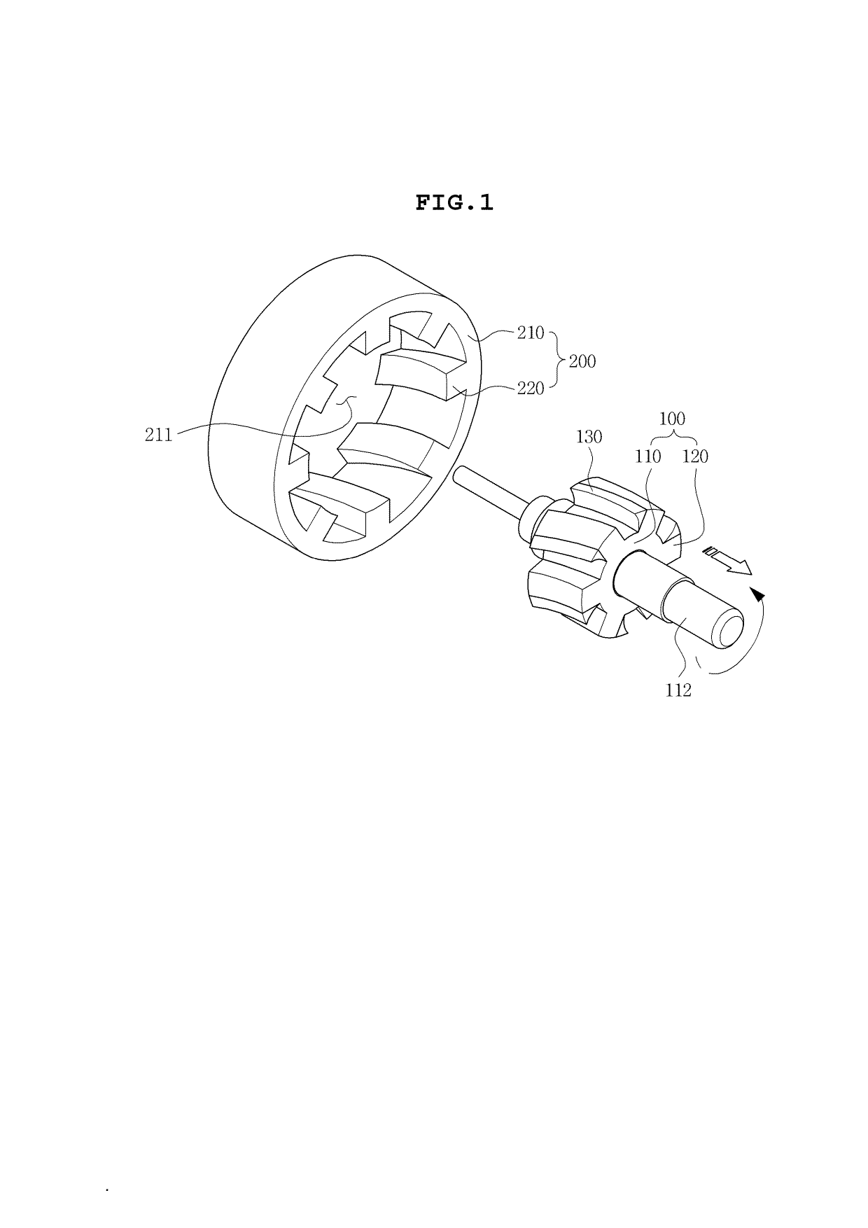

FIG. 1 is an exploded perspective view of a switched reluctance motor according to a first preferred embodiment of the present invention. As shown in FIG. 1, the switched reluctance motor is configured to include a rotor part 100, a stator part 200, auxiliary rotor poles 130, and coils (not shown).

The rotor part 100 includes a rotor core 110 made of a metal material and a plurality of rotor poles 120.

More specifically, a hollow hole 111 is formed at a central portion of the rotor core 110, and a shaft 112 is fixedly coupled to the hollow hole 111 to transfer rotational force of the rotor part 100 to the outside.

In addition, the plurality of rotor poles 120 are formed to protrude along an outer peripheral surface of the rotor core 110, the rotor pole 120a and the rotor pole 120b form a fluid suction channel 121 in order to suck or discharge an external fluid at the time of rotation of the rotor part 100.

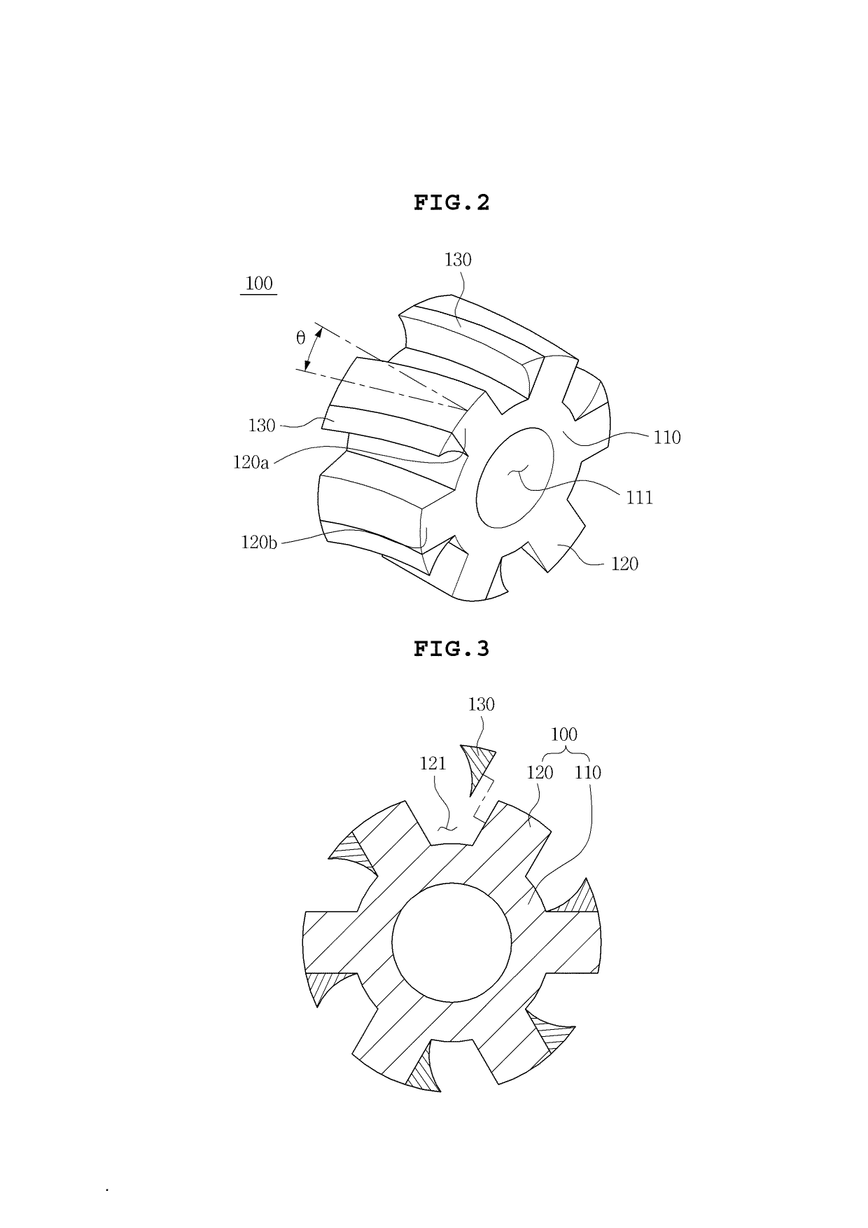

FIG. 2 is an assembly perspective view of the rotor part and the auxiliary rotor pole shown in FIG. 1, and FIG. 3 is a cross-sectional view of the rotor part and the auxiliary rotor pole shown in FIG. 2. As shown in FIGS. 2 and 3, the auxiliary rotor pole 130 is fixedly coupled to an outer portion of the rotor pole 120.

More specifically, the auxiliary rotor pole 130 is coupled to the outer portion of the rotor pole 120 to rotate integrally with the rotor part 100.

In addition, the auxiliary rotor pole 130 is made of any one of a plastic material and a synthetic resin, such that the auxiliary rotor pole 130 does not interfere with movement of the flux by electromagnetic interaction between the rotor part 100 and the stator part 200 according to the preferred embodiment of the present invention.

In addition, as shown in FIG. 2, the auxiliary rotor pole 130 is fixedly coupled to the outer portion of each of the rotor poles 120 so as to be disposed at the fluid suction channel 121 formed between the rotor poles 120.

Further, as shown in FIG. 3, the auxiliary rotor pole 130 is coupled to the outer portion of the rotor pole 120 in order to easily suck or discharge the external fluid, such that a cross-section of the rotor part 100 has a propeller shape.

Therefore, in the switched reluctance motor according to the first preferred embodiment of the present invention, even though a propeller shaped fan is not additionally coupled to the shaft 112, only the rotor part 110 may suck or discharge the external fluid.

As shown, the stator part 200 includes a stator yoke 210 made of a metal material and a plurality of stator salient poles 220.

More specifically, the stator yoke 210 may have a cylindrical shape in which a hollow part 211 having an inner diameter larger than an outer diameter of the rotor part 100 is formed so that the rotor part 100 is rotatably received therein.

In addition, the plurality of stator salient poles 220 are formed to protrude from an inner peripheral surface of the stator yoke 210 so as to face the rotor pole 120 and have coils (not shown) wound therearound multiple times, wherein the coils receive power from the outside.

In addition, the stator salient pole 220 may have a skew shape having a predetermined angle.

Therefore, a torque ripple generated between the rotor part 100 and the stator part 200 may be reduced, and fluid may be moved at the time of rotation.

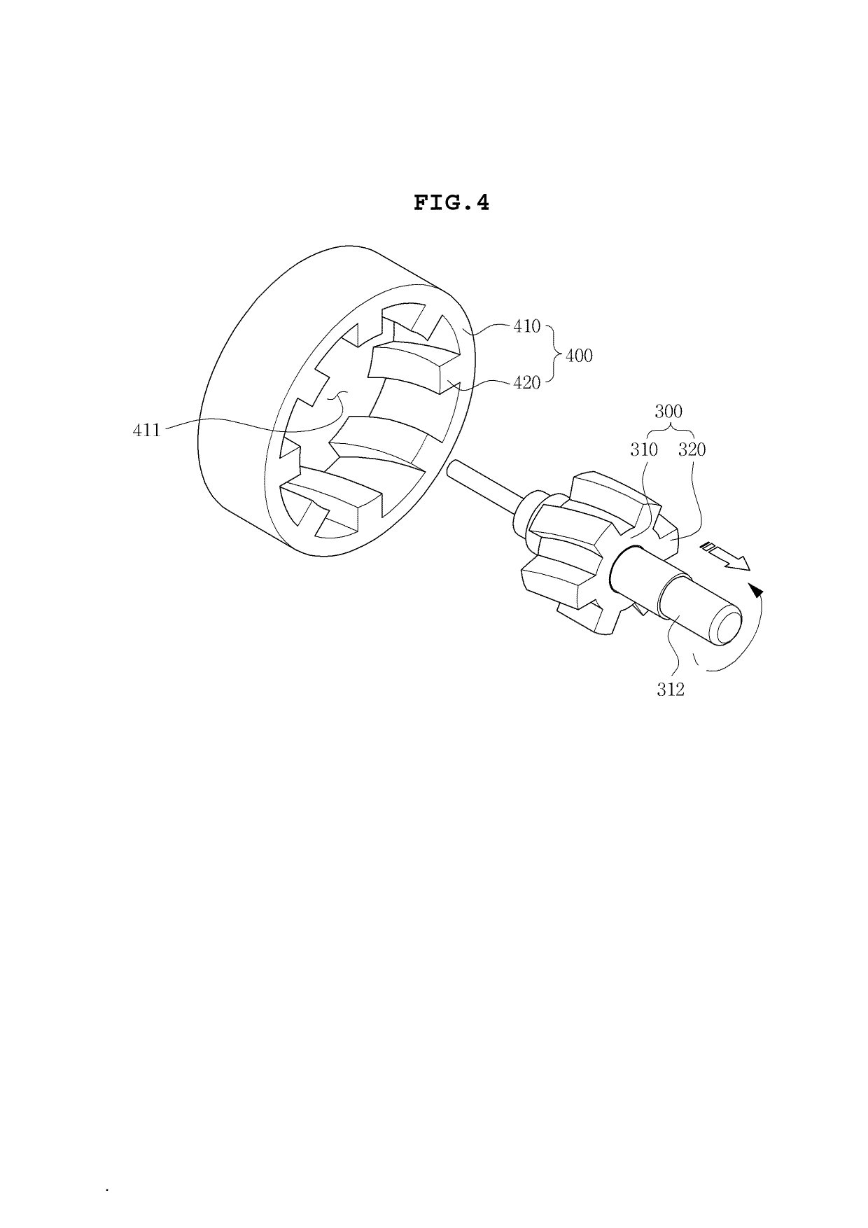

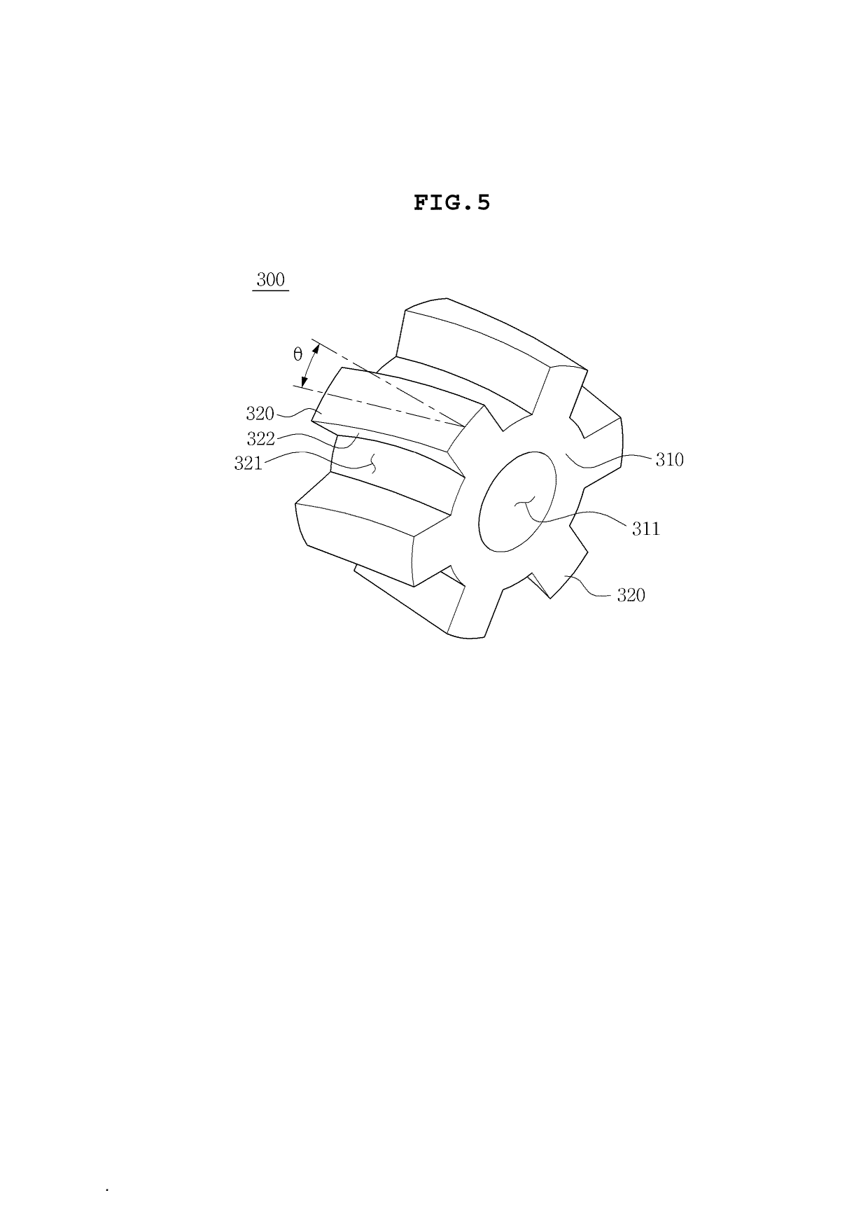

FIG. 4 is an exploded perspective view of a switched reluctance motor according to a second preferred embodiment of the present invention, and FIG. 5 is a perspective view of a rotor part shown in FIG. 4. In describing the present embodiment, the same or corresponding components to the foregoing preferred embodiments are denoted by the same reference numerals and therefore, the description of the overlapping portions will be omitted. Hereinafter, the switched reluctance motor according to the preferred embodiment of the present invention will be described with reference to FIGS. 4 and 5.

As shown in FIG. 4, the switched reluctance motor is configured to include a rotor part 300, a stator part 400, and coils (not shown).

The rotor part 300 includes a rotor core 310 made of a metal material and a plurality of rotor poles 320.

More specifically, a hollow hole 311 is formed at a central portion of the rotor core 310, and a shaft 312 is fixedly coupled to the hollow hole 311 to transfer rotational force of the rotor part 300 to the outside.

In addition, the plurality of rotor poles 320 are formed to protrude along an outer peripheral surface of the rotor core 310, neighboring two rotor poles form a fluid suction channel 321 in order to suck or discharge an external fluid at the time of rotation of the rotor part 300.

In addition, the rotor pole 320 has a skew shape in which the rotor pole 320 is inclined from one end to a distal end by a predetermined angle (θ) based on the shaft 312.

In addition, an outer side surface 322 of the rotor pole 320 in a direction of the fluid suction channel 321 formed between the rotor poles 320 is curved, such that a cross-section of the rotor part 300 has a propeller shape.

Therefore, in the switched reluctance motor according to the second preferred embodiment of the present invention, even though a propeller shaped fan is not additionally coupled to the shaft 312, only the rotor part 300 may suck or discharge the external fluid.

According to the preferred embodiment of the present invention, the rotor part having the propeller shape is included in the switched reluctance motor, such that the additional propeller for transferring the fluid to the desired place needs not be required, thereby making it possible to implement thinness of the motor and reduce manufacturing cost.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A switched reluctance motor comprising:
a rotor part including a rotor core of which a shaft fixedly coupled to a central portion and a plurality of rotor poles protruding from the rotor core;
a stator part including a stator yoke rotatably receiving the rotor part therein and a plurality of stator salient poles protruding from the stator yoke so as to face the rotor poles; and
auxiliary rotor poles coupled to outer portions of the rotor poles to rotate integrally with the rotor part.

2. The switched reluctance motor as set forth in claim 1, wherein the auxiliary rotor pole is made of any one of a plastic material and a synthetic resin.

3. The switched reluctance motor as set forth in claim 1, further comprising coils wound around the stator salient pole multiple times.

4. The switched reluctance motor as set forth in claim 1, wherein the auxiliary rotor pole is fixedly coupled to the outer portion of the rotor pole so as to be disposed at a fluid suction channel formed between the rotor poles.

5. The switched reluctance motor as set forth in claim 4, wherein a cross-section of the rotor part in which the auxiliary rotor pole is fixedly coupled to the outer portion of the rotor pole is a propeller shape.

6. The switched reluctance motor as set forth in claim 1, wherein the stator salient pole has a skew shape having a predetermined angle.

7. A switched reluctance motor comprising:
a rotor part including a rotor core of which a shaft is fixedly coupled to a central portion and a plurality of rotor poles protruding from the rotor core;
a stator part including a stator yoke rotatably receiving the rotor part therein and a plurality of stator salient poles protruding from the stator yoke so as to face the rotor poles,
wherein the rotor pole is inclined by a predetermined angle based on the shaft.

8. The switched reluctance motor as set forth in claim 7, wherein the rotor pole has a skew shape in which the rotor pole is inclined from one end to a distal end by a predetermined angle based on the shaft.

9. The switched reluctance motor as set forth in claim 7, wherein a cross-section of the rotor part is a propeller shape.

10. The switched reluctance motor as set forth in claim 7, further comprising coils wound around the stator salient pole multiple times.

11. The switched reluctance motor as set forth in claim 7, wherein the stator salient pole has a skew shape having a predetermined angle.
